(19) United States
(12) Patent Application Publication
(10) Pub. No.: US 2009/0161029 A1
(43) Pub. Date: Jun. 25, 2009

(54) DISPLAY DEVICE

(75) Inventor: Masafumi SAKAGUCHI, Suwa-shi (JP)

Correspondence Address: Workman Nydegger;1000 Eagle Gate Tower, 60 East South Temple, Salt Lake City, UT, 84111, US

(73) Assignee: Seiko Epson Corporation, Tokyo (JP)

(21) Appl. No.: 12/340,914

(22) Filed: Dec. 22, 2008

(30) Foreign Application Priority Data
Dec. 25, 2007 (JP) 2007-331594

(51) Int. Cl. H04N 5/74

(52) U.S. Cl. 348/751; 348/E05.137

(57) ABSTRACT

A display device includes a light source and an image generating unit that modulates light from the light source and generates an image. The image generating unit includes a color modulating element that performs color modulation for the light of the light source based on color information separated from image information, a luminance modulating element that performs luminance modulation for the light of the light source based on luminance information separated from the image information, and a relay optical system that relays the light of the light source between the color modulating element and the luminance modulating element. The relay optical system includes a focus adjusting mechanism that images an optical image at one modulating element between the color modulating element and the luminance modulating element on the light incident side of the other modulating element.

### BACKGROUND

1. Technical Field

The present invention relates to a display device.

2. Related Art

Recently, improvement of display devices such as LCDs (Liquid Crystal Displays), EL (Electro-Luminescence) displays, plasma displays, CRTs (Cathode Ray Tubes), or projectors is remarkable, and devices having capability that almost matches human's visual features in terms of the resolution and the color gamut are implemented. However, in terms of the luminance dynamic range, the reproducible range is about 1 to 10² [nit], and, generally, the number of gray scale levels is 8 bits. On the other hand, the human's sight has the luminance dynamic range that can be perceived at once is from about 10⁻² to 10⁴ [nit]. In addition, the human's sight has the luminance determining capability of 0.2 [nit]. Thus, when the luminance determining capability is converted into the number of gray scale levels, it corresponds to about 12 bits. When a displayed image of a current display device is viewed through such visual features, narrowness of the luminance dynamic range is recognized visually. In addition, since the gray scale levels for a shadow part or a highlight part are insufficient, a viewer feels insufficient reality and strength of the displayed image.

In addition, in CG (Computer Graphics) used in a movie, a game, or the like, movement for pursuing reality of representation by implementing the luminance dynamic range and the characteristics of the gray scale that are close to those of human's sight into display data (hereinafter, referred to as HDR (High Dynamic Range) display data) becomes a mainstream trend. However, since the capability of the display device that displays the display data is insufficient, there is a problem that the expressive power included in the CG contents cannot be sufficiently exhibited.

In addition, in the next version of an OS (Operating System), employment of a 16-bit color space is scheduled, and accordingly, the dynamic range and the number of gray scale levels increase remarkably, compared with the currently used 8-bit color space. Accordingly, it is expected that the request for implementing an electronic display device having a high dynamic range and high gray scale that can utilize the 16-bit space increases.

Among display devices, projection-type display devices (projectors) such as liquid crystal projectors are display devices that are effective for displaying on a large-sized screen and reproducing the reality and strength of the display image. In this field, in order to solve the above-described problems, the following has been proposed (for example, see JP-A-2005-284058).

In a projection-type display device disclosed in JP-A-2005-284058, light reflected in a first direction by a first light modulating element is incident to a light composing unit through a second light modulating element, the light reflected in the second direction by the first light modulating element is directly incident to the light composing unit, and thus, the use efficiency of light is improved. As a result, the above-described projection-type display device implements both the enlargement of the luminance dynamic range and improvement of the gray scale capability.

However, the light reflected by the first light modulating element cannot be easily incident to the second light modulating element in a superposing manner. In addition, in some cases, moiré occurs, and thus, there is a possibility that the image quality of display markedly deteriorates.

### SUMMARY

An advantage of some aspects of the invention is that it provides a display device capable of enlarging the luminance dynamic range and increasing the number of gray scale levels.

According to a first aspect of the invention, there is provided a display device including: a light source; and an image generating unit that modulates light from the light source and generates an image. The image generating unit includes: a color modulating element that performs color modulation for the light of the light source based on color information separated from image information; a luminance modulating element that performs luminance modulation for the light of the light source based on luminance information separated from the image information; and a relay optical system that relays the light of the light source between the color modulating element and the luminance modulating element. The relay optical system includes a focus adjusting mechanism that images an optical image at one modulating element between the color modulating element and the luminance modulating element on the light incident side of the other modulating element.

According to the above-described display device, the color-modulated light that is modulated, for example, by the color modulating element is relayed to the luminance modulating element by the relay optical system. For the color-modulated light that is relayed to the luminance modulating element, luminance modulation is additionally performed so as to generate an image. In such a case, in a state that an optical image modulated by the color modulating element is imaged, the optical image is relayed to the luminance modulating element by the focus adjusting mechanism of the relay optical system. Accordingly, enlargement of the luminance dynamic range and an increase in the number of gray scale levels can be implemented while moiré is reduced.

In the above-described display device, it is preferable that the color modulating element and the luminance modulating element are configured by liquid crystal light valves, a color-modulating liquid crystal light value that configures the color modulating element has a color modulating area including a plurality of pixels each formed of a plurality of sub pixels that modulates color light of different colors, and color filters of different colors are disposed for the plurality of sub pixels.

In such a case, since each pixel of the color-modulating liquid crystal light value has a plurality of sub pixels, it is possible to configure the color modulating element by using one liquid crystal light valve. Accordingly, the image generating unit is configured by two liquid crystal light valves and the relay optical system, and thereby the configuration of the device can be simplified.

In addition, it may be configured that a luminance-modulating liquid crystal light valve that configures the luminance modulating element has a luminance modulating area corresponding to the plurality of pixels of the color-modulating liquid crystal light valve.

In such a case, the pixel structure is simplified, compared to the pixel structure of the color modulating element, and accordingly, the manufacturing cost can be reduced.

Alternatively, it may be configured that the luminance modulating area corresponds to each of the plurality of sub pixels of the color-modulating liquid crystal light valve.

In such a case, the luminance-modulating liquid crystal light valve can be manufactured from skipping a color filter forming process in the process for manufacturing the color-modulating liquid crystal light valve. Accordingly, the manufacturing cost of the luminance modulating element can be reduced.

In the above-described display device, it is preferable that the luminance modulating element performs luminance modulation for each area, which includes the plurality of pixels, of the luminance modulating area.

In such a case, the luminance information is controlled for each area of the image, and accordingly, control of the luminance modulating element can be simplified.

In addition, in the above-described display device, it is preferable that the color modulating element is disposed on the light source side of the relay optical system.

In such a case, since the luminance information that is modulated by the luminance modulating element is composed with the color information modulated by the color modulating element, boundary parts of the colors of RGB that constitute each image can be gradated, and accordingly, a smooth image can be acquired.

In addition, in the above-described display device, it is preferable that the luminance modulating element is disposed on the light source side of the relay optical system.

In such a case, since the color information modulated by the color modulating element is composed with the luminance information modulated by the luminance modulating element, RGB colors constituting each image can be clearly displayed, and accordingly, a clear image can be acquired.

According to a second aspect of the invention, there is provided a display device including: a light source; and an image generating unit that modulates light from the light source and generates an image. The image generating unit has: a plurality of color modulating elements that perform color modulation for color light of different colors which is emitted from the light source based on color information separated from image information; a color composing unit that composes light that is modulated by the plurality of color modulating elements; a luminance modulating element that performs luminance modulation for light projected from the color composing unit based on luminance information separated from the image information; and a relay optical system that relays the light of the light source between the color composing unit and the luminance modulating element. In addition, the relay optical system includes a focus adjusting mechanism that images an optical image composed by the color composing unit on the light incident side of the luminance modulating element.

According to the above-described display device, even when a so-called three-plate structure in which three color modulating units are disposed for the color light of the RGB colors from the light source is used, the optical image composed by the color composing unit is relayed to the luminance modulating element in an imaged state by the focus adjusting mechanism of the relay optical system. Accordingly, enlargement of the luminance dynamic range and an increase in the number of gray scale levels can be implemented while moiré is reduced.

In addition, in the above-described display device, it is preferable that a color dividing unit that divides the light emitted from the light source into a plurality of types of color light is further included. In addition, it is preferable that the light source emits the light that includes the plurality of types of color light and the color light divided by the color dividing unit is incident to each of the plurality of color modulating elements.

In such a case, by using a light source, for example, that emits white light, light of one light source can be incident to the plurality of color modulating elements. Accordingly, the configuration of the device can be simplified.

In addition, in the above-described display device, it is preferable that a projection unit that is disposed on a side, which is opposite to the light source, of the image generating unit and projects the image generated by the image generating unit onto a projection surface is further included.

In such a case, the image generated by the image generating unit can be projected on the projection surface on an enlarged scale. Accordingly, a small-sized image generating unit can be used, and thereby miniaturization of the whole device can be implemented.

Here, the projection unit may be a projection lens.

In such a case, a projection-type image display device capable of displaying a high contrast image with high precision, for example, on a screen as the projection surface can be provided.

Alternatively, the projection unit may be an eyepiece.

In such a case, it is possible to enable a user to visually check a high-contrast image with high precision. As a result, a display device that is appropriate to an electric view finder used as a finder of a camera can be provided.

### BRIEF DESCRIPTION OF THE DRAWINGS

The invention will be described with reference to the accompanying drawings, wherein like numbers reference like elements.

FIG. 1 is a schematic plan view showing the configuration of a projector according to an embodiment of the invention.

FIG. 2 is a schematic diagram showing the configuration of light valves for color modulation and luminance modulation according to an embodiment of the invention.

FIG. 3 is a diagram showing a light path between color-modulating and luminance-modulating liquid crystal light valves according to an embodiment of the invention.

FIG. 4 is a diagram showing the configuration of a projector according to a second embodiment of the invention.

FIG. 5 is a diagram showing the configuration according to a third embodiment of the invention.

FIG. 6 is a diagram showing the configuration according to a modified example of the invention.

FIG. 7 is a diagram showing the configuration of a projector according to a fourth embodiment of the invention.

### DESCRIPTION OF EXEMPLARY EMBODIMENTS

### First Embodiment

Hereinafter, a display device according to a first embodiment of the invention will be described with reference to the accompanying drawings. In drawings below, in order to have each member in a recognizable size, the scale of each member is appropriately changed. The display device according to this embodiment is an example of a projection image display device (projector) of double-modulation type in which liquid crystal light valves are employed on both sides of a color modulating element that performs color modulation for light from a light source and a luminance modulating element that performs luminance modulation for light from a light source.

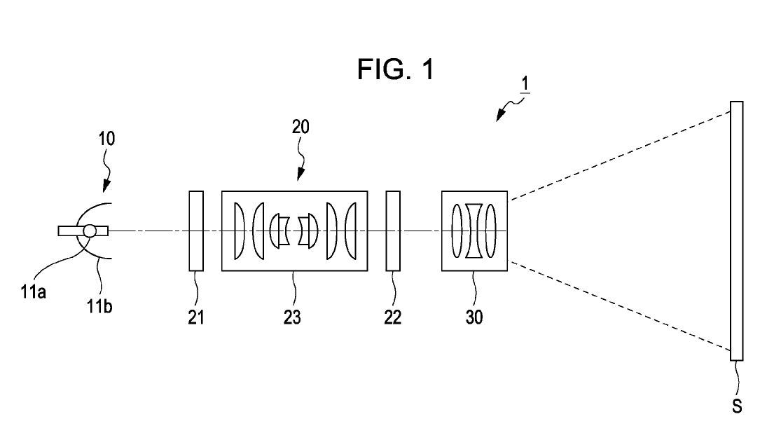

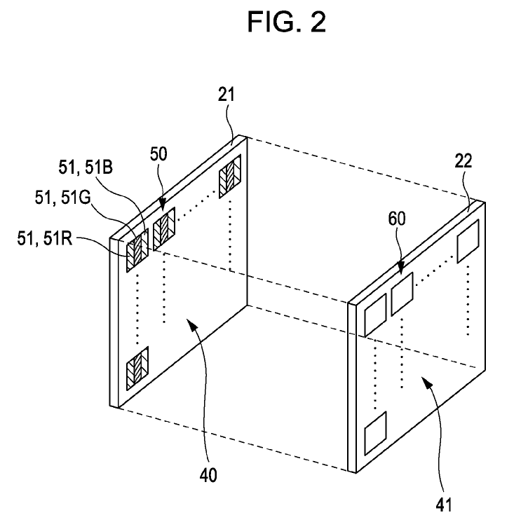

FIG. 1 is a schematic diagram (a plan view) showing the configuration of a projector (display device) according to this embodiment. FIG. 2 is a diagram showing a schematic configuration of a color-modulating liquid crystal light valve (the color modulating element) and a luminance-modulating liquid crystal light valve (the luminance modulating element) of the projector. The projector according to this embodiment is configured to divide image information into color information and luminance information, perform color modulation by using the color-modulating liquid crystal light valve based on the color information, and perform luminance modulation by using the luminance-modulating liquid crystal light valve based on the luminance information.

In particular, the projector 1, as shown in FIG. 1, includes a light source 10, an image generating unit 20 that modulates the light emitted from the light source 10 and generates an image, and a projection lens (projection unit) 30. The projector 1 is configured to project the image generated by the image generating unit 20 onto a screen (projection surface) S through the projection lens 30 on an enlarged scale.

The light source 10 includes a high-pressure mercury lamp 11a that emits light and a reflector 11b that reflects the light emitted from the high-pressure mercury lamp 11a. The high-pressure mercury lamp 11a is a lamp that emits white light including color light of various colors.

In addition, although not shown in the figure, between the light source 10 and the image generating unit 20, one pair of fly-eye lenses that forms uniform luminance distribution of light incident from the light source 10 may be disposed. In addition, following the fly-eye lenses, a polarization converting element that converts light that is in a uniform indefinite polarized state into light having a specific polarized direction may be disposed. The polarization converting element, for example, is configured by a PBS array and a half wavelength plate and can convert randomly polarized light into a straight polarized light.

The image generating unit 20 includes a color-modulating liquid crystal light valve 21 that performs color modulation for light from the light source 10, a luminance-modulating liquid crystal light valve 22 that performs luminance modulation for light from the light source 10, and a relay lens (a relay optical system) 23 that relays light of the light source 10 between the color-modulating liquid crystal light valve 21 and the luminance-modulating liquid crystal light valve 22. In other words, the relay lens 23, to be described in detail, is configured to superpose the light (optical image) that is modulated by the color-modulating liquid crystal light valve 21 on the luminance-modulating liquid crystal light valve 22.

In this embodiment, from the light source 10 side, the color-modulating liquid crystal light valve 21, the relay lens 23, and the luminance-modulating liquid crystal light valve 22 are sequentially disposed. The color-modulating liquid crystal light valve 21 projects color-modulated light including an optical image which is acquired from performing color modulation for incident light of the light source 10 based on the color information separated from the image data. Then, the color-modulated light is superposed (incident) on the luminance-modulating liquid crystal light valve 22 by the relay lens 23. The luminance-modulating liquid crystal light valve 22 generates an image by additionally performing luminance modulation for the light (color-modulated light) of the light source 10 based on the luminance information separated from the image data.

The color-modulating liquid crystal light valve 21 is configured by a transmission-type liquid crystal device. In particular, the color-modulating liquid crystal light valve 21 is an active-matrix type liquid crystal display element formed by interposing a TN (Twisted Nematic) type liquid crystal between a TFT array substrate in which pixel electrodes and switching elements such as thin film transistors or thin film diodes for driving the pixel electrodes are formed in a matrix shape and an opposing substrate in which a common electrode is formed over the whole face and disposing a polarizing plate on the outer face thereof.

The color-modulating liquid crystal light valve 21 is driven in a normally-white mode in which white/bright (transmission) state is formed with no application of a voltage or a normally-black mode in which black/dark (non-transmission) state is formed with application of a voltage. The gray scale of the color-modulating liquid crystal light valve is controlled between bright and dark states in an analog mode in accordance with the applied voltage value.

As shown in FIG. 2, the color-modulating liquid crystal light valve 21 has a color-modulating area 40 that includes a plurality of pixels 50 each formed of a plurality of sub pixels that modulate color light of different colors. In addition, each pixel 50 is configured to include a plurality of sub pixels 51 that modulate color light of different colors. In this embodiment, each pixel 50 is configured by three sub pixels 51. In addition, in the sub pixels 51, color filters of different colors are disposed. Here, the sub pixel 51 in which a color filer for transmitting R (red) light is formed is referred to as a sub pixel 51R, the sub pixel 51 in which a color filer for transmitting G (green) light is formed is referred to as a sub pixel 51G, and the sub pixel 51 in which a color filer for transmitting B (blue) light is formed is referred to as a sub pixel 51B.

Under the above-described configuration, the color-modulating liquid crystal light valve 21 can modulate light passing through the sub pixels 51R, 51G, and 51B and can perform various types of color modulation in the pixels 50, and accordingly, various color information can be generated in the color modulating area 40. As described above, since each pixel 50 has the plurality of sub pixels 51, it is possible to configure the color modulating element by one liquid crystal light valve.

On the other hand, the luminance-modulating liquid crystal light valve 22 is configured by a transmission-type liquid crystal device having the same configuration as that of the above-described color-modulating liquid crystal light valve 21. The luminance-modulating liquid crystal light valve 22 has a luminance modulating area 41, and the luminance modulating area 41 includes a plurality of pixels 60. The pixels 60 correspond to the pixels 50 of the color-modulating liquid crystal light valve 21 and are configured such that the luminance thereof can be modulated.

Here, that the pixel 50 corresponds to the pixel 60 means that modulated light (color modulation) of a pixel 50 is superposed on a predetermined pixel 60. In other words, as the light of the light source 10 is transmitted through the pixels 50 and 60, the color modulation and the luminance modulation are performed in a superposing manner.

In addition, the pixel 60 of the luminance-modulating liquid crystal light valve 22 is configured not to have any sub pixel. In addition, since the luminance-modulating liquid crystal light valve 22 only performs luminance modulation, the luminance-modulating liquid crystal light valve does not have any color filter. As described above, the sub pixel structure of the luminance-modulating liquid crystal light valve 22 is removed so as to simplify the pixel structure of the luminance-modulating liquid crystal light valve 22, and thereby the manufacturing cost of the projector 1 is reduced.

The relay lens 23 is an equi-magnification imaging lens formed of a front-stage lens group and a rear-stage lens group that are disposed to be almost symmetrically with respect to an aperture diaphragm. In addition, it is preferable that the relay lens 23 has two-side telecentricity in consideration of viewing angle characteristics of the light valves 21 and 22. The front-stage lens group and the rear-stage lens group are configured to include a plurality of convex lenses and a plurality of concave lenses. However, the shapes, sizes, dispositional gaps, the number, the telecentricity, the magnification, and other lens characteristics of the lenses may be appropriately changed in accordance with required characteristics.

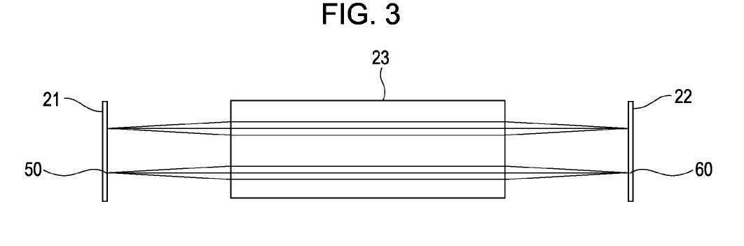

FIG. 3 is a diagram acquired from extracting a light path between the color-modulating liquid crystal light valve 21 and the luminance-modulating liquid crystal light valve 22 from FIG. 1. For easy understanding of description, the light valves 21 and 22 are shown without any thickness.

The relay lens 23, as shown in FIG. 3, includes a focus adjusting mechanism that adjusts a focus such that the color-modulated light modulated by the color-modulating liquid crystal light valve 21 is imaged on the light incident side (that is, the surface of the pixel 60) of the luminance-modulating liquid crystal light valve 22. This focus adjusting mechanism, for example, is configured in various manners by appropriately setting the shapes or curvatures of the convex lenses and the concave lenses. As described above, light modulated by each pixel 50 of the color-modulating liquid crystal light valve 21 is superposed on each pixel 60 of the luminance-modulating liquid crystal light valve 22 in an imaged state, and accordingly, luminance modulation can be performed for an optical image without unsharpness. In addition, enlargement of the luminance dynamic range and an increase in the number of gray scales can be implemented while moiré is reduced.

In addition, in this embodiment, since the color-modulating liquid crystal light valve 21 is disposed on the light source 10 side, an image is formed by performing luminance modulation using the luminance-modulating liquid crystal light valve 22 for the optical image after the color modulation in a superposing manner. Accordingly, by gradating boundary parts of the colors of RGB of pixels that constitute an image, a smooth image quality can be represented on the screen S.

The image generated by the image generating unit 20 is projected onto the screen S through the projection lens 30 on an enlarged scale. As described above, since the projector 1 can project the image onto the screen S on an enlarged scale by using the projection lens 30, the liquid crystal light valves 21 and 22 can be miniaturized. Accordingly, the image generating unit 20 decreases in size. As a result, the projector 1 can be miniaturized.

As described above, the projector 1 according to this embodiment includes the color-modulating liquid crystal light valve 21 that performs color modulation for light of the light source 10, the luminance-modulating liquid crystal light valve 22 that performs luminance modulation for light of the light source 10, and the relay lens 23 that relays light therebetween. Accordingly, the color-modulated light modulated by each pixel 50 of the color-modulating liquid crystal light valve 21 is relayed to each pixel 60 of the luminance-modulating liquid crystal light valve 22 by the relay lens 23. In such a case, the light modulated by the color-modulating liquid crystal light valve 21 is superposed on the luminance-modulating liquid crystal light valve 22 in an imaged state. Accordingly, a multiple-gray scale image of which luminance dynamic range is widened can be generated while moiré is reduced. In addition, according to this embodiment, since the image generating unit 20 is configured by two liquid crystal light valves 21 and 22 and the replay lens 23, the configuration of the device is simplified, and accordingly, the projector 1 miniaturized further can be provided.

### Second Embodiment

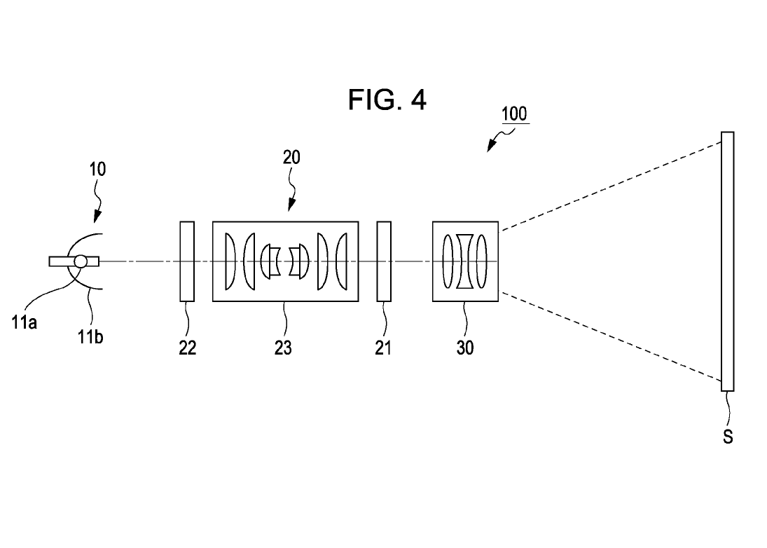

Next, a second embodiment of the invention will be described with reference to FIG. 4. In drawings of embodiments described below, to each configuration that is common to the projector 1 according to the first embodiment, a same reference sign is attached, and a description thereof is omitted or simplified.

In the projector 1 according to the first embodiment, from the light source 10 side, the color-modulating liquid crystal light valve 21, the relay lens 23, and the luminance-modulating liquid crystal light valve 22 are sequentially disposed. On the contrary, in a projector 100 according to this embodiment, from the light source 10 side, the luminance-modulating liquid crystal light valve 22, the relay lens 23, and the color-modulating liquid crystal light valve 21 are sequentially disposed. The luminance-modulating liquid crystal light valve 22 projects luminance-modulated light including an optical image which is acquired from performing luminance modulation for incident light of the light source 10 based on the luminance information separated from the image data. Then, the luminance-modulated light is incident to the color-modulating liquid crystal light valve 21 by the relay lens 23. The color-modulating liquid crystal light valve 21 generates an image by additionally performing color modulation for the light (luminance-modulated light) of the light source 10 based on the color information separated from the image data.

Thus, according to the projector 100 of this embodiment, the luminance-modulated light modulated by the luminance-modulating liquid crystal light valve 22 is imaged on the light incident side (that is, the surface of the pixel 50) of the color-modulating liquid crystal light valve 21. As described above, light modulated by each pixel 60 of the luminance-modulating liquid crystal light valve 22 is superposed on each pixel 50 of the color-modulating liquid crystal light valve 21 in an imaged state, and accordingly, as in the first embodiment, enlargement of the luminance dynamic range and an increase in the number of gray scales can be implemented while moiré is reduced. In addition, in this embodiment, since the luminance-modulating liquid crystal light valve 22 is disposed on the light source 10 side, an image is formed by performing color modulation for the luminance-modulated light in a superposing manner by using the color-modulating liquid crystal light valve 21. Accordingly, the colors of RGB of each pixel constituting the image can be clearly displayed, and thereby the image quality with sharpness can be acquired.

### Third Embodiment

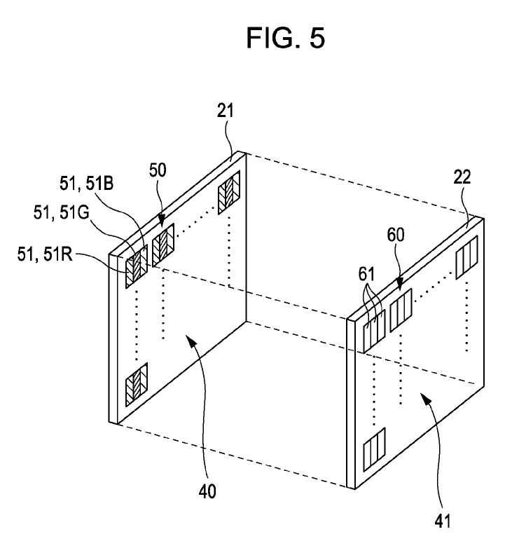

Next, a third embodiment of the invention will be described with reference to FIG. 5. In drawings of embodiments described below, to each configuration that is common to the first and second embodiments, a same reference sign is attached, and a description thereof is omitted or simplified.

In the above-described first and second embodiments, the pixel 60 of the luminance-modulating liquid crystal light valve 22 is configured not to have any sub pixel.

To the contrary, in this embodiment, the pixel 60 of the luminance-modulating liquid crystal light valve 22 is configured to have a same configuration as that of the pixel 50 of the color-modulating liquid crystal light valve 21. In other words, the pixel 60 of the luminance-modulating liquid crystal light valve 22 has three sub pixels 61. As a result, the configuration of the luminance-modulating liquid crystal light valve 22 except for the color filer is the same as that of the color-modulating liquid crystal light valve 21.

Thus, according to this embodiment, a liquid crystal device acquired from skipping a color filter forming process in the process for manufacturing the color-modulating liquid crystal light valve 21 is used as the luminance-modulating liquid crystal light valve 22. Accordingly, the manufacturing cost of the luminance-modulating liquid crystal light valve 22 can be reduced. As a result, a low manufacturing cost of the project 1 can be achieved.

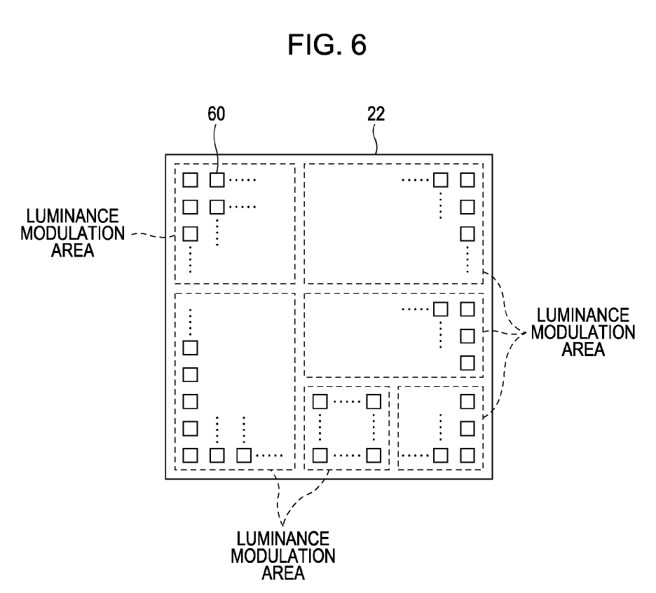

In the above-described first, second, and third embodiments, luminance modulation is performed for each pixel 60 regardless of the pixel structure of the luminance-modulating liquid crystal light valve 22. However, there is a case where the luminance modulation is not needed to be performed necessarily for each pixel 60 depending on an image to be displayed. In such a case, in this embodiment, as shown in FIG. 6, the luminance-modulating liquid crystal light valve 22 can perform the luminance modulation for each area including a plurality of pixels in the luminance modulating area. In other words, it is possible to perform the luminance modulation for each desired area of the image.

Accordingly, under this configuration, luminance modulation can be controlled for each area of the image, and thus, the control operation of the luminance-modulating liquid crystal light valve 22 can be simplified.

### Fourth Embodiment

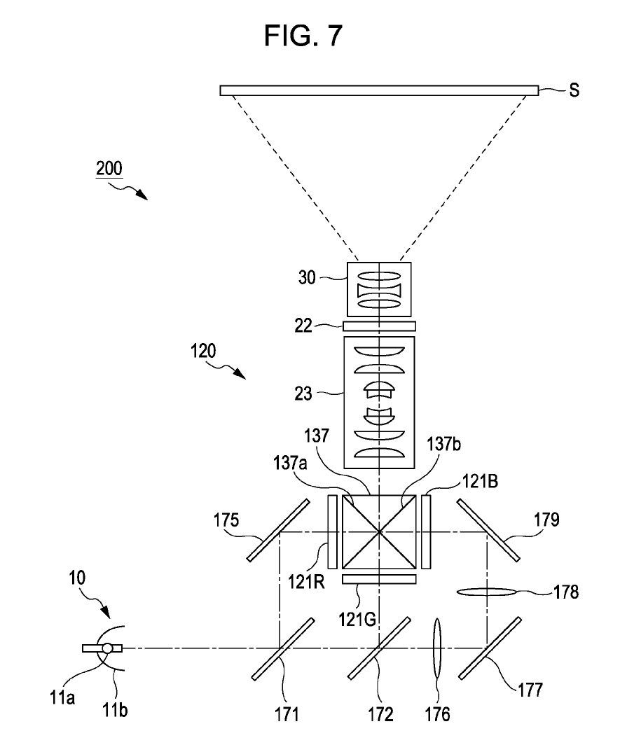

Next, a fourth embodiment of the invention will be described with reference to FIG. 7. In drawings of embodiments described below, to each configuration that is common to the first to third embodiments, a same reference sign is attached, and a description thereof is omitted or simplified.

A projector 200 according to this embodiment includes a light source 10, an image generating unit 120 that modulates the light emitted from the light source 10 and generates an image, and a projection lens (projection unit) 30.

The image generating unit 120 according to this embodiment includes a plurality of color-modulating liquid crystal light valves 121R, 121G, and 121B that perform color modulation for color light of different colors which is emitted from the light source 10, a dichroic prism (color composing unit) 137 that composes light modulated by the color-modulating liquid crystal light valves 121R, 121G, and 121B, a luminance-modulating liquid crystal light valve 122 that performs luminance modulation for the light projected from the dichroic prism 137, and a relay lens 23 that relays light of the light source 10 between the dichroic prism 137 and the luminance-modulating liquid crystal light valve 122.

The light source 10 emits white light including red light (hereinafter, referred to as “R light”), green light (hereinafter, referred to as “G light”), and blue light (hereinafter, referred to as “B light”). The projector 200 according to this embodiment includes a color dividing unit 170 that divides the light emitted from the light source 10 into a plurality of types of light. The color light (R light, G light, and B light) separated by the color dividing unit 170 is configured to be incident to the color-modulating liquid crystal light valves 121R, 121G, and 121B. In other words, the projector 200 according to this embodiment is configured as a so-called three-plate type projector.

Here, each of the color-modulating liquid crystal light valves 121R, 121G, and 121B is configured as a liquid crystal device as in the above-described embodiments. Each of the color-modulating liquid crystal light valves 121R, 121G, and 121B has a color modulating area 40 that includes a plurality of pixels 50. In this embodiment, since one of the R light, the G light, and the B light is incident to each pixel 50, any color filter is not needed.

In addition, the luminance-modulating liquid crystal light valve 122 has a luminance modulating area 41 that includes a plurality of pixels 60. Each pixel 160 of the luminance modulating area 41 corresponds to each pixel 150 of the color modulating area 40. In other words, to each pixel 60 of the luminance modulating area 41, light of each pixel 50 composed by the dichroic prism 137 is incident, as described below.

The color dividing unit 170, as shown in FIG. 7, includes an R light reflecting dichroic mirror 171 that reflects the R light and transmits the G light and the B light of the light emitted from the high-pressure mercury lamp 11a and a G light reflecting dichroic mirror 172 that reflects the G light and transmits the B light.

The light path of the R light of the light emitted from the high-pressure mercury lamp 11a is bent by 90 degrees by the R light reflecting dichroic mirror 171, and the R light is incident to a reflection mirror 175. Then, the light path of the R light is bent by 90 degrees by the reflection mirror 175, and the R light is incident to the color-modulating liquid crystal light valve 121R used for R light. Then, the R light modulated by the color-modulating liquid crystal light valve 121R is incident to the dichroic prism 137.

In addition, the G light of the light emitted from the high-pressure mercury lamp 11a is transmitted through the R light reflecting dichroic mirror 171. Then, the light path of the G light is bent by 90 degrees by the G light reflecting dichroic mirror 172. Next, the G light is incident to the color-modulating liquid crystal light valve 121G that is used for G light. Then, the G light modulated by the color-modulating liquid crystal light valve 121G is incident to the dichroic prism 137.

In addition, the B light of the light emitted from the high-pressure mercury lamp 11a is transmitted through the R light reflecting dichroic mirror 171 and the G light reflecting dichroic mirror 172 and is incident to a reflection mirror 177 through a lens 176. Then, the light path of the B light that is incident to the reflection mirror 177 is bent by 90 degrees, and the B light is incident to a reflection mirror 179 through a lens 178. The light path of the B light incident to the reflection mirror 179 is bent by 90 degrees, and the B light is incident to the color-modulating liquid crystal light valve 121B that is used for the B light. Then, the B light modulated by the color-modulating liquid crystal light valve 121B is incident to the dichroic prism 137.

The dichroic prism 137 has a configuration in which two dichroic films 137a and 137b are disposed to be perpendicular to each other in the shape of an X letter. The dichroic film 137a reflects the B light and transmits the R light and the G light. In addition, the dichroic film 137b reflects the R light and transmits the G light and the B light. As described above, the dichroic prism 137 composes the R light, the G light, and the B light that are modulated by the color-modulating liquid crystal light valves 121R, 121G, and 121B. At that moment, the light modulated by the color-modulating liquid crystal light valves 121R, 121G, and 121B in each pixel 50 is composed by the dichroic prism 137 so as to form an optical image.

The optical image composed by the dichroic prism 137 is superposed on each pixel 60 of the luminance-modulating liquid crystal light valve 22 in an imaged state by the relay lens 23. Accordingly, the luminance modulation can be performed for an optical image without unsharpness, and thus, enlargement of the luminance dynamic range and an increase in the number of gray scales can be achieved while moiré is reduced.

The image generated by the image generating unit 120 is projected onto the screen S through the projection lens 30.

The invention is not limited to the above-described embodiments and may be variously changed without departing from the gist of the invention.

For example, in the first embodiment, the relay lens 23 and the color-modulating liquid crystal light valve 21 and the luminance-modulating liquid crystal light valve 22 are disposed in a state separated from each other. However, the above-described components may be configured to be disposed in a contact state. In addition, any one between the color-modulating liquid crystal light valve 21 and the luminance-modulating liquid crystal light valve 22 may be configured to be brought into contact with the relay lens. In such a case, the image generating unit 20 can be miniaturized, and accordingly, the projector can be further miniaturized.

In addition, in the above-described first to fourth embodiments, the light source 10 that includes the high-pressure mercury lamp 11a and the reflector 11b has been exemplified. However, the invention is not limited thereto. For example, a device that is generally used as an illumination device such as a back light or an organic EL element that is used in a liquid crystal device as a light source may be used as the light source 10 in various manners.

In addition, in the above-described embodiments, a case where the invention is applied to a projection-type display device (the projector) by projecting the image generated by the image generating unit 20 onto a projection surface (the screen S) by a projection unit (the projection lens 30) has been described.

In addition, in the above-described embodiments, a case where both the luminance-modulating liquid crystal light valve and the color-modulating liquid crystal light valve are formed of projection-type liquid crystal devices has been described. However, the invention is not limited thereto, and the luminance-modulating liquid crystal light valve and the color-modulating liquid crystal light valve may be configured by reflection-type liquid crystal devices. Alternatively, a configuration that one between the luminance-modulating liquid crystal light valve and the color-modulating liquid crystal light valve is a projection-type liquid crystal device and the other is a reflection-type liquid crystal device may be used.

In addition, the invention may be applied not only to a projection-type display device but to a direct-view-type display device. In other words, the invention may be applied to a display device in which the projection lens 30 is not disposed and an image generated by the image generating unit 20 is directly viewed to be recognized. In such a case, a multiple gray scale image of which luminance dynamic range is enlarged can be acquired by using a simple configuration.

In addition, as the projection unit that projects the image generated by the image generating unit 20 onto the projection surface, an eyepiece may be used. Under such a configuration, a user can view and recognize a high-contrast image with high precision by looking into the eyepiece. Thus, the invention may be applied to an electric view finder (EVF) that is used as a finder of a digital camera. Additionally, the invention may be applied to an information display device such as a vehicle head-up display (HUD), a micro projector that is used for mobile devices, an instrument panel display of an AV device, or a large-sized information display panel (an electric bulletin board or the like) by utilizing the features of a small size and high precision. For example, the head-up display (HUD) projects an image on a front window shield (partial reflection unit) of a vehicle and can mainly display an information display such as a speed meter, the remaining amount of gasoline, a warning, or the like. Since the head-up display is installed to a narrow dashboard, a small-sized panel with high precision is preferably used for the head-up display, and thus, the display device according to an embodiment of the invention is very appropriate thereto.

The entire disclosure of Japanese Patent Application No. 2007-331594, filed Dec. 25, 2007 is expressly incorporated by reference herein.

What is claimed is:

1. A display device comprising:
a light source; and
an image generating unit that modulates light from the light source to generate an image,
wherein the image generating unit includes:
a color modulating element that performs color modulation on light of the light source based on color information;
a luminance modulating element that performs luminance modulation on light of the light source based on luminance information; and
a relay optical system that relays the light of the light source between the color modulating element and the luminance modulating element,
the relay optical system including a focus adjusting mechanism that images an optical image that is at one of the color modulating element and the luminance modulating element onto a light incident side of another of the color modulating element and the luminance modulating element.

2. The display device according to claim 1,
wherein the color modulating element and the luminance modulating element are configured by liquid crystal light valves,
wherein a color-modulating liquid crystal light valve that configures the color modulating element has a color modulating area including a plurality of pixels each formed of a plurality of sub pixels that modulates color light of different colors, and
wherein color filters of different colors are disposed for the plurality of sub pixels.

3. The display device according to claim 2, wherein a luminance-modulating liquid crystal light valve that configures the luminance modulating element has a luminance modulating area corresponding to the plurality of pixels of the color-modulating liquid crystal light valve.

4. The display device according to claim 3, wherein the luminance modulating area corresponds to each of the plurality of sub pixels of the color-modulating liquid crystal light valve.

5. The display device according to claim 3, wherein the luminance modulating element performs luminance modulation for each area, which includes the plurality of pixels, of the luminance modulating area.

6. The display device according to claim 1, wherein the color modulating element is disposed on the light source side of the relay optical system.

7. The display device according to claim 1, wherein the luminance modulating element is disposed on the light source side of the relay optical system.

8. A display device comprising:
a light source; and
an image generating unit that modulates light from the light source to generate an image,
wherein the image generating unit has:
a plurality of color modulating elements that perform color modulation on color light of different colors which is emitted from the light source based on color information;
a color composing unit that composes light that is modulated by the plurality of color modulating elements;
a luminance modulating element that performs luminance modulation on light projected from the color composing unit based on luminance information; and
a relay optical system that relays the light of the light source between the color composing unit and the luminance modulating element,
the relay optical system including a focus adjusting mechanism that images an optical image composed by the color composing unit onto the light incident side of the luminance modulating element.

9. The display device according to claim 8, further comprising a color dividing unit that divides the light emitted from the light source into a plurality of types of color light,
wherein the light source emits the light that includes the plurality of types of color light, and
wherein the color light divided by the color dividing unit is incident to each of the plurality of color modulating elements.

10. The display device according to claim 1, further comprising a projection unit that is disposed on a side, which is opposite to the light source, of the image generating unit and projects the image generated by the image generating unit onto a projection surface.

11. The display device according to claim 10, wherein the projection unit is a projection lens.

12. The display device according to claim 10, wherein the projection unit is an eyepiece.
